(19) United States
(12) Patent Application Publication
(10) Pub. No.: US 2026/0214288 A1
(43) Pub. Date: Jul. 23, 2026

(54) TRANSFER OF STREAMING CONTENT TO A DISPLAY DEVICE

(71) Applicant: GOOGLE LLC, Mountain View, CA (US)

(72) Inventors: Philipp Terres, Pfäffikon (CH); Daniel Harms, Mountain View, CA (US); Marian Grocholski, Santa Clara, CA (US); Zhengnan Zhao, Newark, CA (US); Xiang Shi, New York, NY (US); Brandon Mousseau, Port Orchard, WA (US); Siarhei Salnikov, Zürich (CH); Zachary Allegretti, Union City, CA (US); Michael DelGaudio, Mountain View, CA (US); Cory Mitchell O'Connor, Menlo Park, CA (US); Hanwook Kim, Honolulu, HI (US); Rohan Dhing, Los Angeles, CA (US)

(73) Assignee: GOOGLE LLC, Mountain View, CA (US)

(21) Appl. No.: 19/142,550

(22) PCT Filed: Dec. 27, 2023
(86) PCT No.: PCT/US2023/086055

§ 371 Date: Jun. 23, 2025

Related U.S. Application Data
(60) Provisional application No. 63/478,049, filed on Dec. 30, 2022.

(51) Int. Cl. H04N 21/41; H04N 21/414; H04N 21/436; H04N 21/462; H04N 21/472; H04N 21/482; H04N 21/485; H04N 21/858

(52) U.S. Cl. CPC H04N 21/4122; H04N 21/41265; H04N 21/414; H04N 21/436; H04N 21/4622; H04N 21/47202; H04N 21/47217; H04N 21/482; H04N 21/485; H04N 21/8586

(57) ABSTRACT

According to an aspect, a method includes rendering, by a media aggregator application executable by a user device, a user interface that identifies a plurality of media content items hosted from a plurality of streaming platforms, connecting the media aggregator application to a network-enabled display device, rendering a user interface (UI) control on the user interface for streaming a media content item of the plurality of media content items on the network-enabled display device, and, in response to selection of the UI control, transmitting a cast request to the network-enabled display device over a network, where the cast request, when executed by the network-enabled display device, is configured to launch a native application on the network-enabled display device and cause the native application to stream the media content item on a display of the network-enabled display device.

### CROSS-REFERENCE TO RELATED APPLICATION

This application claims priority to U.S. Provisional Patent Application No. 63/478,049, filed on Dec. 30, 2022, the disclosure of which is incorporated by reference herein in its entirety.

### BACKGROUND

Media content may be delivered to a user device through an application, and the user may be required to perform multiple steps to access the media content through the device's application before being able to cast (e.g., transfer, share) the media content to a display device.

### SUMMARY

In some aspects, the techniques described herein relate to a method including: rendering, by a media aggregator application executable by a user device, a user interface that identifies a plurality of media content items hosted from a plurality of streaming platforms; connecting the media aggregator application to a network-enabled display device; rendering a user interface (UI) control on the user interface for streaming a media content item of the plurality of media content items on the network-enabled display device; and in response to selection of the UI control, transmitting a cast request to the network-enabled display device over a network, the cast request, when executed by the network-enabled display device, configured to launch a native application on the network-enabled display device and cause the native application to stream the media content item on a display of the network-enabled display device.

In some aspects, the techniques described herein relate to a non-transitory computer-readable medium storing executable instructions that when executed by at least one processor cause the at least one processor to execute operations, the operations including: receiving, at a network-enabled display device, a cast request, over a network, from a media aggregator application executable by a user device, the cast request identifying a media content item to be streamed on the network-enabled display device; determining whether a native application associated with the media content item is installed on an operating system of the network-enabled display device; in response to the native application associated with the media content item being determined as installed on the operating system of the network-enabled display device, launching the native application; and generating a view intent, the view intent including a content deep link that identifies the media content item within the native application, the view intent, when executed by the native application, configured to cause the native application to stream the media content item on a display of the network-enabled display device.

In some aspects, the techniques described herein relate to a system including: at least one processor; and a non-transitory computer-readable medium storing executable instructions that execute a media aggregator application on a user device, the media aggregator application configured to: render a user interface that identifies a plurality of media content items from a plurality of streaming platforms; connect the media aggregator application to a network-enabled display device; render a user interface (UI) control on the user interface for streaming a media content item of the plurality of media content items on the network-enabled display device; and in response to selection of the UI control, transmit, over a network, a cast request to the network-enabled display device, the cast request, when executed by the network-enabled display device, configured to launch a native application on the network-enabled display device and cause the native application to stream the media content item on a display of the network-enabled display device.

The details of one or more implementations are set forth in the accompanying drawings and the description below. Other features will be apparent from the description and drawings, and from the claims.

### BRIEF DESCRIPTION OF THE DRAWINGS

FIGS. 1A through 1C illustrate a system for connecting a media aggregator application to a display device to initiate and control playback of a media content item on the display device's display according to an aspect.

FIGS. 2A through 2E illustrate example user interfaces of the media aggregator application according to an aspect.

FIGS. 3A through 3C illustrate example user interfaces of the media aggregator application according to another aspect.

FIGS. 4A through 4F illustrate example user interfaces of the media aggregator application according to another aspect.

FIGS. 5A through 5E illustrate example user interfaces of the media aggregator application according to another aspect.

FIG. 6 illustrates a flowchart depicting example operations of a media aggregator application according to an aspect.

FIG. 7 illustrates a flowchart depicting example operations of a network-enabled display device according to an aspect.

### DETAILED DESCRIPTION

A user device (e.g., smartphone, tablet, laptop, etc.) may execute one or more native applications for streaming media content from a streaming platform. A user may launch a particular native application and view media content that is available for streaming on the mobile computing device. For example, a first native streaming application may identify first media content for streaming from a first streaming platform, and a second native streaming application may identify second media content for streaming from a second streaming platform.

The user device may also execute a media aggregator application configured to aggregate information about media content available from the various native streaming platforms and present the information in a single user interface so that a user can identify and/or search media content across different native streaming platforms (e.g., without having to search within each native streaming application). For example, the aggregator application may provide a user interface (e.g., single user interface) to allow the user to identify media content from multiple streaming platforms.

The disclosure relates to a mechanism that enables the media aggregator application to connect to a network-enabled display device (e.g., a smart television).

When connected, the user may use the media aggregator application to initiate playback of a media content item (e.g., a movie, show, program, live broadcast, etc.) on the network-enabled display device. For example, a user may identify a media content item, associated with a particular native streaming application, from the user interface of the media aggregator application, and, in response to selection of a user interface (UI) element (e.g., a cast icon) on the media aggregator application, the media aggregator application initiates playback of the media content item on the network-enabled display device without using the computing device's native streaming application associated with the media content item. For example, the media aggregator application may communicate with the network-enabled display device (e.g., transmit a cast request) to launch a corresponding native streaming application, installed on an operating system of the network-enabled display device, to play back the identified media content item.

When connected to the network-enabled display device, the media aggregator application may provide a virtual remote to control one or more aspects (e.g., volume, power on, power off, etc.) of the network-enabled display device and to control the playback of video content on the network-enabled display device (e.g., pause, play, forward, rewind, stop, etc.). Furthermore, since the cast request is initiated from the media aggregator application itself, the user interface of the media aggregator application may remain in the foreground on the user device to allow the user to continue to view information provided by the media aggregator application such as details of the selected media content item or other media content available for streaming from other streaming platforms.

With respect to a particular example, the media aggregator application may identify movie A and indicate that movie A is available to be streamed from a first streaming platform. When the media aggregator application and the network-enabled display device are connected, the media aggregator application may display a UI control (e.g., cast icon), which, when selected, causes the media aggregator application to communicate with the network-enabled display device's operating system to launch a native application, associated with the first streaming platform, on the network-enabled display device and playback movie A on the network-enabled display device. In this manner, the underlying native application (associated with the first streaming platform) on the user device is not used to facilitate the casting of movie A on the network-enabled display device. Further, the media aggregator application may provide a virtual remote to control the playback of the media content items as well as controls that control functions of the network-enabled display device (e.g., power, volume up, volume down, etc.).

In a conventional approach, when the user selects movie A from the media aggregator application, the media aggregator application may cause the underlying native streaming application (associated with the first streaming platform) on the user device to be launched. In a conventional approach, the user may use the underlying native application to cast movie A to the display device. However, according to the techniques discussed herein, the user may facilitate the playback of movie A (e.g., the media content item) on the network-enabled display device directly from the media aggregator application on the user device. In this manner, because the underlying native application is not used to facilitate the transfer (e.g., casting, sharing, etc.) of the media content item to the network-enabled display device, the amount of computing resources that are typically required to cast media content to a display device may be reduced. Furthermore, during (and after) casting to the network-enabled display device, the user interface of the media aggregator may continue to be rendered in the foreground, thereby allowing the user to use the media aggregator application to view information about the media content item and/or other media content provided by other streaming platforms.

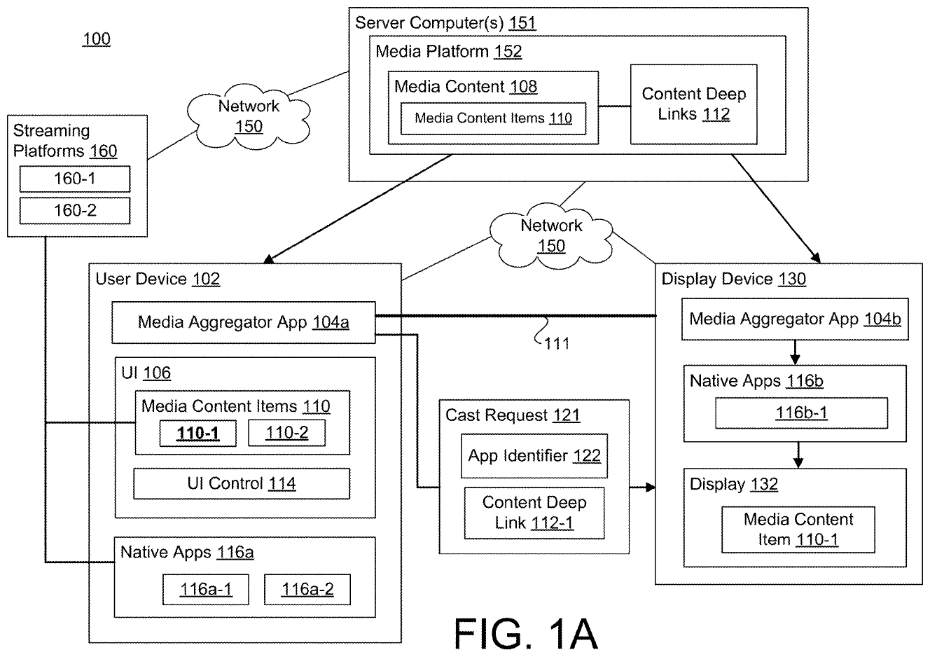

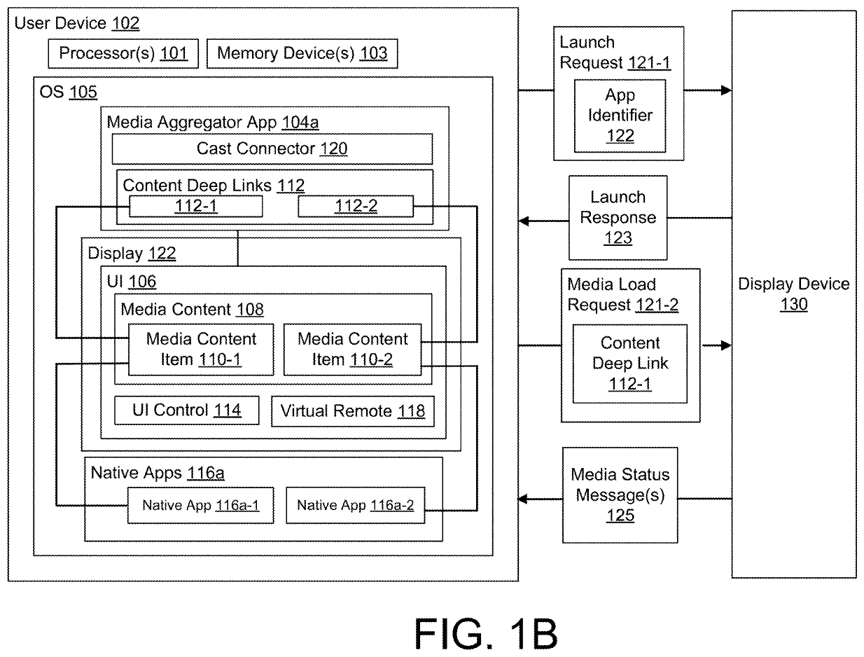

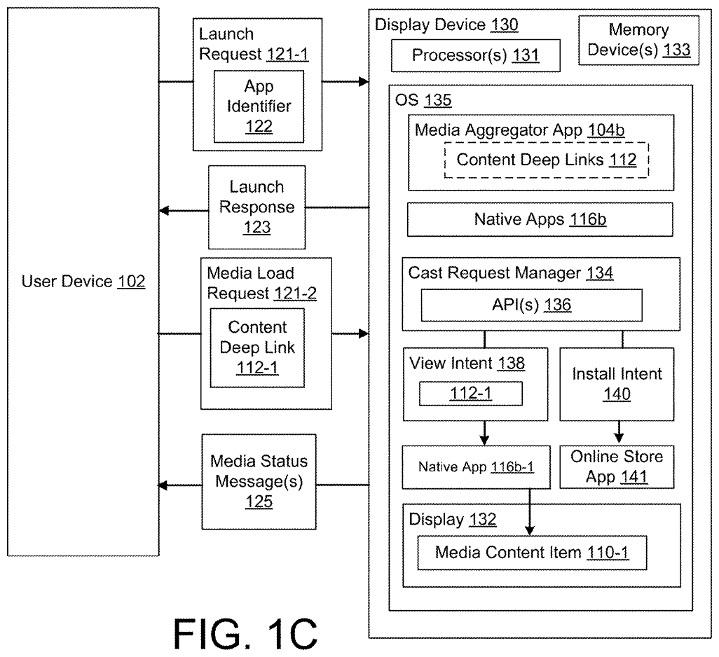

FIGS. 1A through 1C illustrate a system 100 for connecting a media aggregator application 104a, executing on a user device 102, to a display device 130 (e.g., a network-enabled display device) and initiating playback of a media content item 110-1 from (e.g., directly from) a user interface 106 of the media aggregator application 104a, where the content of the media content item 110-1 is displayed on the display device 130. Also, playback (e.g., pause, fast forward, rewind, power-on, power-off, volume, etc.) of the media content item 110-1 may be controlled via the user interface 106 of the media aggregator application 104a.

The system 100 of FIG. 1A includes a user device 102 configured to execute a media aggregator application 104a, one or more server computers 151 configured to execute a media platform 152 to identify and provide media content 108 (e.g., including media content items 110) for display and selection in the user interface 106 of the media aggregator application 104a, and a display device 130 configured to stream a media content item 110-1 that has been selected by the user from the media aggregator application 104a. FIG. 1B illustrates an example of the user device 102 and example communications with the display device 130. FIG. 1C illustrates an example of the display device 130 and example communications with the media aggregator application 104a executing on the user device 102.

The media aggregator application 104a (e.g., in conjunction with the media platform 152) may aggregate (e.g., combine, assemble, collect, etc.) information about media content 108 available for viewing (e.g., streaming) from multiple streaming platforms 160 and present the information in a user interface 106 (e.g., a single, unified user interface) so that a user can identify and/or search media content 108 across different streaming platforms 160 (e.g., without having to search within each native application 116a). The media content 108 includes a plurality of media content items 110 that are available for streaming from one or more streaming platforms 160. Each media content item 110 may be a television show, a movie, a live broadcast, etc. For example, instead of searching for media content items on the native application 116a-1 and media content items on the native application 116a-2, the media aggregator application 104a may combine the media content items 110 together in one interface (e.g., user interface 106) so that a user can search across multiple streaming platforms 160 at once.

The media platform 152 may communicate, over a network 150, with the streaming platforms 160 to identify which media content items 110 are available to be streamed by user devices 102 and identify a set or multiple sets of media content items 110 (e.g., across the various streaming platforms 160) as recommendations to a user of the media aggregator application 104a. In some examples, the media platform 152 may determine whether the user of the media aggregator application 104a has rights (e.g., entitlements) to stream media content 108 from one or more of the streaming platforms 160 (e.g., whether the user has subscribed to access media content 108 from the streaming platform(s) 160), and, if so, may include those media content items 110 as candidates in a selection (e.g., ranking) mechanism to potentially be displayed in the user interface 106 of the media aggregator application 104a.

The user interface 106 may display a plurality of media content items 110, which may be selected by the media platform 152 based at least in part on information representing the user's interests and activities (e.g., the user's search queries, search results, previous watch history, purchase history, application usage history, application installation history, user actions on the network-connected television device, physical activities of the user, etc.). In some examples, the media aggregator application 104a may be associated with a user account, and the user account may store the information representing the user's interests and activities, and the media platform 152 may use this information to select and present the media content items 110 in the user interface 106. In some examples, the media content items 110 may be organized as a plurality of clusters based on one or more categories, such as: content type (e.g., “Action Movies”), viewing history (e.g., “Because You watched Movie ABC”), release time (e.g., “Trending”), and the like. In some examples, the media content items 110 provided by different streaming platforms 160 (e.g., action movies from two different streaming services and a broadcast television channel) can be recommended in the same cluster. In some examples, the user interface 106 may include tabbed interfaces, where one of the tabbed interfaces includes personalized media content that is organized as a plurality of clusters based on one or more categories, such as: release time (e.g., “This Week,” “Next week,” “Next Month,” etc.), user action and user application interaction, native app usage (e.g., items that are “From App ABC”), etc.

It is noted that a user of the media aggregator application 104a may be provided with controls allowing the user to make an election as to both if and when the system 100 may enable the collection of information representing the user's interests and activities. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user of the media aggregator application 104a may have control over what information is collected about the user, how that information is used, and what information is provided to the user and/or to the server computer 151.

In some examples, the media platform 152 may receive content deep links 112 associated with the media content items 110 from the streaming platforms 160 and store the content deep links 112. In some examples, the media platform 152 may generate a content deep link 112 associated with one or more media content items 110. A content deep link 112 may be an identifier that links to particular content (e.g., the corresponding media content item 110) within a native application 116a. In some examples, the content deep link 112 is an operating system intent. In some examples, the content deep link 112 is a uniform resource locator (URL). In some examples, the content deep link 112 includes a URL format.

A content deep link 112-1, corresponding to the media content item 110-1, may be an identifier that identifies the location of the media content item 110-1 in the native application 116a-1. In some examples, the content deep link 112-1 identifies a specific landing page (e.g., an interface) within the native application 116a-1 that corresponds to the media content item 110-1. Similarly, a content deep link 112-2, corresponding to the media content item 110-2, may be an identifier that identifies the location of the media content item 110-2 in the native application 116a-2. In some examples, the content deep link 112-2 identifies a specific landing page within the native application 116a-2 that corresponds to the media content item 110-2.

The media aggregator application 104a may communicate, over the network 150, with the media platform 152 to receive the identified media content items 110, across the various streaming platforms 160, for display in the user interface 106 of the media aggregator application 104a. Displaying a media content item 110 in the user interface 106 may include displaying UI element(s) (e.g., icon) in the user interface 106 that identifies a corresponding media content item 110 along with information about the media content item (e.g., title, description, underlying streaming platform 160, etc.). For each media content item 110, the media aggregator application 104a may receive a corresponding content deep link 112. For example, the media platform 152 may transmit, over the network 150, information that identifies the media content items 110 to be displayed in the user interface 106 of the media aggregator application 104a and the content deep links 112 associated with the media content items 110. In some examples, the media content items 110 are personalized to a particular user of the media aggregator application 104a so different media aggregator applications 104a associated with different users may display media content 108 that is specific to a particular user.

A media content item 110 may correspond to a digital video file, which may be stored on the streaming platforms 160 (including the media platform 152) and/or the user device 102. In some examples, the media platform 152 is also considered a streaming platform 160, which may store and provide digital video files for streaming. The digital video file may include video and/or audio data that corresponds to the particular media content item 110. Streaming (or playback) of a media content item 110 may refer to the transmission of the contents of a video file from the location of the video file (e.g., the streaming platform 160) to the device that displays the contents of the video file (e.g., the user device 102 or the display device 130). In some examples, streaming (or playback) of a media content item 110 may refer to a continuous video stream that is transferred from one place to another place in which a received portion of the video stream is displayed while waiting for other portions of the video stream to be transferred (e.g., transferred across the network 150).

As shown in FIGS. 1A and 1B, the media aggregator application 104a may display a media content item 110-1 and media content item 110-2. In some examples, the media content item 110-1 corresponds to a video file that is available for streaming from a streaming platform 160-1. In some examples, the media content item 110-2 is a video file that is available for streaming from a streaming platform 160-2.

Although two media content items 110 are depicted in FIGS. 1A and 1B, it is noted that the media aggregator application 104a may display any number of media content items 110 across any number of streaming platforms 160. In some examples, the media content items 110 are displayed as selectable UI icons in the user interface 106, which, when a particular media content item 110 is selected from the user interface 106, the media aggregator application 104a may initiate playback of the selected media content item 110.

The streaming platform 160-2 may be a streaming service that is different from the streaming platform 160-1. In some examples, the media content item 110-1 and/or the media content item 110-2 is/are available for streaming from the media platform 152, which, in some examples, is a streaming service that stores video files available for streaming. In some examples, the streaming platform 160-1 and/or the streaming platform 160-2 are streaming services in which the user of the media aggregator application 104a has a subscription to view media content 108 from that respective streaming service. Each streaming platform 160 (including, in some examples, the media platform 152) may include one or more server computers that are associated with a separate streaming service and may store the video files that includes the content (e.g., video/audio data) associated each media content item 110 that is available for streaming from a respective streaming platform 160. In some examples, one or more of the streaming platforms 160 are executable by the server computer(s) 151 that also executes the media platform 152.

The user device 102 may also include native applications 116a executable by an operating system 105 of the user device 102. The native applications 116a may be streaming applications associated with the streaming platforms 160. A native application 116a is a software program that is developed for use on a particular platform or device, or for a particular operating system. In some examples, the native application 116a is a software program that is developed for multiple platforms or devices. In some examples, the native application 116a is a software program developed for use on a mobile platform and/or configured to execute on a desktop or laptop computer. In some examples, the native applications 116a may include one or more mobile applications. A mobile application is a native application configured to execute on a mobile operating system of a mobile computing device such as a smartphone or a tablet. In some examples, the mobile applications can execute on a larger device such as a laptop or desktop computer. In some examples, the mobile applications may include an Android application, a mobile iOS application, and/or a mobile Windows application configured to execute on a mobile and/or desktop operating system. In some examples, the native applications 116a may include one or more Linux applications (e.g., Linux applications in a virtualized environment).

A native application 116a-la may be launched to stream a media content item 110-1 that is available on the streaming platform 160-1, and a native application 116a-2 may be launched to stream a media content item 110-2 that is available on the streaming platform 160-2. In other words, a user may launch and use the native application 116a-1 to search for media content items 110 provided by the streaming platform 160-1, and the user may launch and use the native application 116a-2 to search for media content items 110 provided by the streaming platform 160-2.

When browsing media content items 110 in the native application 116a-1, the user may select the media content item 110-1 from the user interface of the native application 116a-1, which may cause play back of the media content item 110-1 on the user device 102 from the streaming platform 160-1. When browsing media content items 110 in the native application 116a-2, the user may select media content item 110-2 from the user interface of the native application 116a-2, which may cause play back of the media content item 110-2 on the user device 102 from the streaming platform 160-2.

However, instead of locating the media content item 110 from the individual native applications 116a, the user may use the media aggregator application 104a to search for media content items 110 across various streaming platforms 160.

When browsing media content items 110 in the media aggregator application 104a, the user may identify and select the media content item 110-1 (e.g., select a selectable icon associated with the media content item 110-1), associated with the streaming platform 160-1, which may cause the underlying native application 116a-1 to be launched on the user device 102 and play back of the media content item 110-1 on the user device 102 may be initiated from the user interface of the native application 116a-1. In other words, selection of the media content item 110-1 from the media aggregator application 104a may cause the media aggregator application 104a to launch the native application 116a-1 (e.g., using the content deep link 112-1), which the user can control to start the playback of the media content item 110-1 from the native application 116a-1 on the user device 102. In some examples, instead of playing back the media content item 110-1 on the user device 102, the user may use the native application 116a-1 to transfer (e.g., cast, share, etc.) the media content item 110-1 to the display device 130, which may include transferring the video/audio data from the native application 116a-1 to the display device 130.

However, according to the techniques discussed herein, the user may facilitate the play back of the media content item 110-1 on the display device 130 from (e.g., directly from) the media aggregator application 104a on the user device 102. In this manner, because the native application 116a-1 is not used to facilitate the rendering of the media content item 110-1, the amount of computing resources that are typically required to cast the media content item 110-1 to a display device 130 may be reduced. In addition, before (e.g., immediately before), during, and/or after (e.g., immediately after) the media content item 110-1 has been casted to the display device 130, the user interface 106 of the media aggregator application 104a may be displayed (e.g., continues to be displayed) in the foreground of the display 132 of the user device 102, thereby allowing the user to use the media aggregator application 104a to view information about the media content item 110-1 and/or other media content items 110 provided by other streaming platforms 160.

The media aggregator application 104a may include a cast connector 120 configured to connect the media aggregator application 104a to the display device 130. In some examples, the cast connector 120 is configured to connect the media aggregator application 104a to an operating system 135 of the display device 130. In some examples, the cast connector 120 is configured to establish a wireless communication link 111 between the media aggregator application 104a and an operating system 135 of the display device 130. In some examples, the wireless communication link 111 is a short-range wireless connection such as a Bluetooth connection. In some examples, the wireless communication link 111 is a Wi-Fi (e.g., direct Wi-Fi) connection. In some examples, when the display device 130 is connected to the media aggregator application 104a, the media aggregator application 104a is configured to communicate with the operating system 135 of the display device 130. In some examples, the operating system 135 of the display device 130 may include one or more application programming interface(s) 136 that is used to enable communication between the media aggregator application 104a and the display device 130. In some examples, the operating system 135 may define a cast request manager 134, and the cast request manager 134 may include the API(s) 136 used to communicate between the media aggregator application 104a and the display device 130 (e.g., the operating system 135).

The cast connector 120 may detect nearby display devices 130 that are available to be connected to the media aggregator application 104a. In some examples, the cast connector 120 may scan nearby devices (e.g., Bluetooth scan or Wi-Fi scan) to detect available display devices 130. In some examples, the cast connector 120 may detect available display devices 130 that are connected to a Wi-Fi network that is also connected to the user device 102. In some examples, to have a display device 130 to be available to be connected to the media aggregator application 104a, the display device 130 may be paired with the media aggregator application 104a. In some examples, in response to a display device 130 being detected (e.g., Bluetooth scan or Wi-Fi scan), a pairing code may be displayed on the display device 130, which the user submits on the user interface 106 of the media aggregator application 104a. Upon submission of the pairing code, the display device 130 may be eligible to be connected to the display device 130.

If a first display device and a second display device are detected, the user interface 106 may identify the first display device and the second display device, where the user can select one of the display devices 130. In response to selection of the first display device (e.g., an icon representing the first display device), the cast connector 120 may connect the first display device to the media aggregator application 104a. In some examples, the cast connector 120 may connect only one display device 130 to the media aggregator application 104a at a time, where, to connect the second display device, the user may have to disconnect the first display device and then connect the second display device.

When the media aggregator application 104a is connected to the display device 130, the media aggregator application 104a may render a UI control 114 on the user interface 106 for initiating playback of a media content item 110 on the display device 130. The UI control 114 may be a graphical UI element, menu item, user affordance, or generally any type of UI element that, when selected, causes playback of the corresponding media content item 110 to be played back on the display device 130. For example, as indicated above, the media aggregator application 104a may render a user interface 106 that identifies a plurality of media content items 110 provided by a plurality of streaming platforms 160. If a user selects a particular media content item 110 (e.g., a UI icon that represents the media content item 110-1), the user interface 106 may display an interface that identifies additional information about the media content item 110-1 along with the UI control 114.

In response to selection of the UI control 114, the media aggregator application 104a may generate and transmit, over the network 150, a cast request 121 to the display device 130. The cast request 121, when executed by the display device 130, is configured to launch a native application 116b-1 and cause the native application 116b-1 to stream the media content item 110-1 (from the corresponding streaming platform 160) for display on a display 132 of the display device 130. The native application 116b-1 may be another instance of the native application 116a-1, but the native application 116b-1 is installed on the operating system 135 of the display device 130. For example, the native application 116b-1 and the native application 116a-1 may be separate instances of the same application.

The cast request 121 may include information that identifies the media content item 110-1 and/or information that identifies the underlying streaming platform 160 (or native application) that provides the media content item 110-1. In some examples, the cast request 121 includes an application identifier 122 associated with the native application 116a-1 (and 116b-1) and/or a content deep link 112-1 that identifies a location of the media content item 110-1 within the native application 116a-1 (and 116b-1). In some examples, the cast request 121 includes the application identifier 122. In some examples, the cast request 121 includes the content deep link 112-1.

In some examples, the cast request 121 does not include the content deep link 112-1. In some examples, the display device 130 already includes the content deep link 112-1. In some examples, a media aggregator application 104b may execute on the operating system 135 of the display device 130, where the media aggregator application 104b may be a separate instance of the media aggregator application 104a, and, therefore, the media aggregator application 104b may include any of the details described with reference to the media aggregator application 104a. In some examples, the media aggregator application 104b may receive the content deep links 112 from the media platform 152 in the same manner as discussed with reference to the media aggregator application 104a. In some examples, in response to the cast request 121, the display device 130 may derive the content deep link 112-1 from the media aggregator application 104b. In some examples, in response to the cast request 121, the display device 130 may obtain the content deep link 112-1 from the media platform 152.

In some examples, the media aggregator application 104a is configured to transmit a single request, which, when received at the display device 130, causes the native application 116b-1 to be launched and the media content item 110-1 to be played back on the display 132 of the display device 130. In some examples, the cast request 121 includes two or more requests, e.g., a launch request 121-1 and a media load request 121-2, as shown in FIGS. 1B and 1C.

For example, in response to selection of the UI control 114, the media aggregator application 104a may generate and transmit a launch request 121-1. If the UI control 114 is selected with respect to the media content item 110-1, the launch request 121-1 may include the application identifier 122 associated with the native application 116a-1 (and 116b-1). In some examples, the application identifier 122 is the name of the application. In some examples, the application identifier 122 is an identifier (e.g., letters, numbers, symbols, etc.) that can uniquely identify the native application 116a-1 (and 116b-1).

As shown in FIG. 1C, the operating system 135 may include a cast request manager 134 configured to receive and transmit information between the display device 130 and the user device 102. The cast request manager 134 may include the API(s) 136 that are configured to enable communication with a connected user device 102. The cast request manager 134 may be a sub-component of the operating system 135 of the display device 130. In response to receiving the launch request 121-1, the cast request manager 134 may determine whether the native application 116b-1, which corresponds to the application identifier 122 included in the launch request 121-1, is installed on the operating system 135 of the display device 130. For example, the cast request manager 134 may obtain information from a memory device 133 of the display device 130 that indicates which native applications 116b are installed on the operating system 135. The cast request manager 134 may use the application identifier 122 to determine whether the native application 116b-1 is included on the information obtained from the memory device 133.

If the cast request manager 134 determines that the native application 116b-1 is not installed on the operating system 135 of the display device 130, the cast request manager 134 may generate and send an installation intent 140 to an online store application 141 that has been installed on the operating system 135. The online store application 141 may be one of the native applications 116b that has been installed on the operating system 135 of the display device 130. The online store application 141 may be any type of application, executable by a display device 130, that can download and install native applications 116b on the operating system 135 of the display device 130. Some examples of online store application 141 may include Google Play Store, LG Content Store, Smart Hub application, Apple Store, etc.

In some examples, the installation intent 140 may include the application identifier 122 associated with the media content item 110-1. In some examples, the cast request manager 134 may transmit the installation intent 140 via an inter-process communication link that enables the cast request manager 134 (e.g., a sub-component of the operating system 135) and the online store application 141 to communicate with each other. The installation intent 140, when executed by the online store application 141, may cause the online store application 141 to render an installation page on the display 132 to enable the user to install the native application 116b-1 on the operating system 135. In response to the native application 116b-1 being installed on the operating system 135, the cast request manager may cause the native application 116b-1 to be launched, e.g., initialized on the display device 130. In response to the native application 116b-1 being launched, the cast request manager 134 generates and transmits a launch response 123 to the user device 102.

If the cast request manager 134 determines that the native application 116b-1 is already installed on the operating system 135 of the display device 130, the cast request manager 134 causes the native application 116b-1 to be launched, e.g., initialized on the display device 130. In response to the native application 116b-1 being launched, the cast request manager 134 generates and transmits the launch response 123 to the media aggregator application 104a on the user device 102. The launch response 123 may indicate that the native application 116b-1 has been launched on the display device 130.

In response to the launch response 123, the media aggregator application 104a on the user device 102 may generate and transmit a media load request 121-2 to the display device 130. The media load request 121-2 may include the content deep link 112-1 associated with the media content item 110-1. In response to receiving the media load request 121-2, the cast request manager 134 may generate a view intent 138 that includes the content deep link 112-1. The view intent 138, when executed by the native application 116b-1, causes the native application 116b-1 to stream the item's content from the streaming platform 160-1, thereby causing playback of the media content item 110-1 on the display 132 of the display device 130.

When connected to the display device 130, the media aggregator application 104a may provide a virtual remote 118 to control one or more aspects (e.g., volume, power on, power off, etc.) of the display device 130 and to control the playback of video content on the display device 130 (e.g., pause, play, forward, rewind, stop, etc.). For example, the user can use the virtual remote 118 to control the playback of the media content item 110-1, control aspects of the display device 130 (e.g., volume, power), and disconnect from the display device 130. Furthermore, since the cast request 121 (e.g., the launch request 121-1, the media load request 121-2) is initiated from the media aggregator application 104a itself, the user interface 106 of the media aggregator application 104a may remain in the foreground to allow the user to continue to view information provided by the media aggregator application 104a such as details of the media content item 110-1 or other media content 108 available for reviewing from other native streaming platforms 160.

The media aggregator application 104a is configured to update the virtual remote 118 based on media status messages 125 received from the display device 130. For example, the media aggregator application 104a may receive, over the network 150, a media status message 125 from the display device 130 and update a display aspect of the virtual device remote 118 based on the media status message 125. In some examples, the media status message 125 may include information that identifies an image, title, application metadata (e.g., name), playback state (e.g., playing, paused buffering, etc.), media duration, and/or current duration position. For example, the virtual remote 118 may provide a timeline with a slider control that shows the progress of the media content item 110-1 and/or information that indicates which media content item 110 is playing on the display device 130. In some examples, position of the slider control and/or the information that indicates which media content item 110 is playing on the display device 130 is based on the media status messages 125 from the display device 130.

The display device 130 may be a network-enabled display device configured to connect to the network 150. In some examples, the display device 130 includes a television (e.g., a smart television). The display device 130 includes one or more processors 131, one or more memory devices 133, and an operating system 135 configured to execute (or assist with executing) one or more native applications 116b, including a media aggregator application 104b. In some examples, the operating system 135 is a browser application. A browser application is a web browser configured to access information on the Internet and may launch one or more browser tabs in the context of one or more browser windows. In some examples, the operating system 135 is a Linux-based operating system. In some examples, the operating system 135 is a mobile operating system that is also configured to execute on smaller devices (e.g., smartphones, tablets, wearables, etc.). The media aggregator application 104b may be a separate instance of the media aggregator application 104a, and, therefore, may include any of the details discussed with reference to the media aggregator application 104b. In some examples, the display device 130 is not a smart television, but is converted to a smart television when connected to a casting device, where the casting device is configured to connect to the network 150 and execute an operating system 135 configured to execute native applications 116b, including the media aggregator application 104b.

The user device 102 may be any type of computing device that includes one or more processors 101, one or more memory devices 103, and an operating system 105 configured to execute (or assist with executing) one or more native applications 116a, including the media aggregator application 104a. In some examples, the user device 102 includes a display 132 (e.g., a liquid crystal display (LCD), light-emitting diode (LED) display, etc.). In some examples, the user device 102 is a smartphone. In some examples, the user device 102 is a tablet. In some examples, the user device 102 is a wearable device. In some examples, the user device 102 is a laptop or desktop computer.

The operating system 105 is a system software that manages computer hardware, software resources, and provides common services for computing programs. In some examples, the operating system 105 is an operating system for a smaller display 132 such as a tablet or a smartphone (e.g., sometimes referred to as a mobile operating system). In some examples, the operating system 105 is an operating system designed for a larger display 132 such as a laptop or desktop (e.g., sometimes referred to as a desktop operating system).

The processor(s) 101 may be formed in a substrate configured to execute one or more machine executable instructions or pieces of software, firmware, or a combination thereof. The processor(s) 101 can be semiconductor-based-that is, the processors can include semiconductor material that can perform digital logic. The memory device(s) 103 may include a main memory that stores information in a format that can be read and/or executed by the processor(s) 101. The memory device(s) 103 may include one or more random-access memory (RAM) devices and/or one or more read-only memory (ROM) devices. The memory device(s) 103 may store applications (e.g., the operating system 105, native applications 116a, etc.) and modules (e.g., cast connector 120) that, when executed by the processors 101, perform certain operations.

The server computer 151 may be computing devices that take the form of a number of different devices, for example a standard server, a group of such servers, or a rack server system. In some examples, the server computer 151 may be a single system sharing components such as processors and memories. The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within network 150. Network 150 may further include any number of hardwired and/or wireless connections.

The server computer 151 may include one or more processors formed in a substrate, an operating system (not shown) and one or more memory devices. The memory devices may represent any kind of (or multiple kinds of) memory (e.g., RAM, flash, cache, disk, tape, etc.). In some examples (not shown), the memory devices may include external storage, e.g., memory physically remote from but accessible by the server computer 151. The server computer 151 may include one or more modules or engines representing specially programmed software.

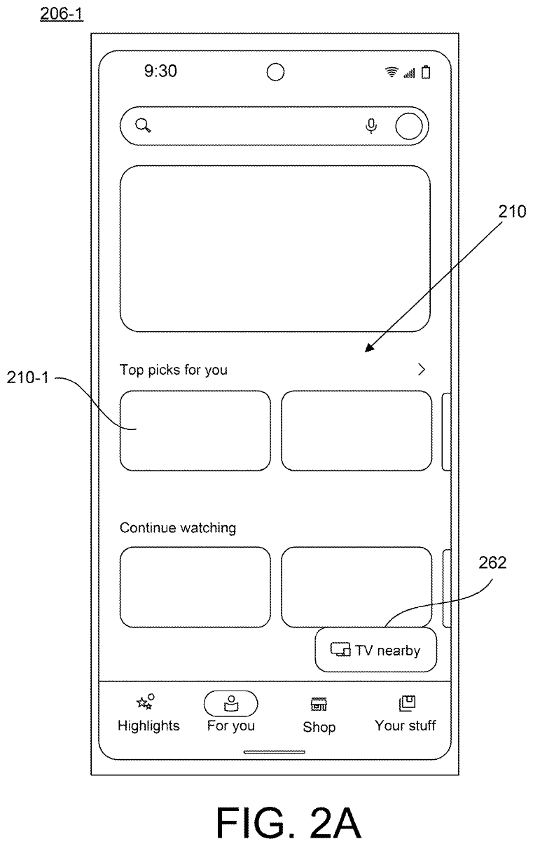

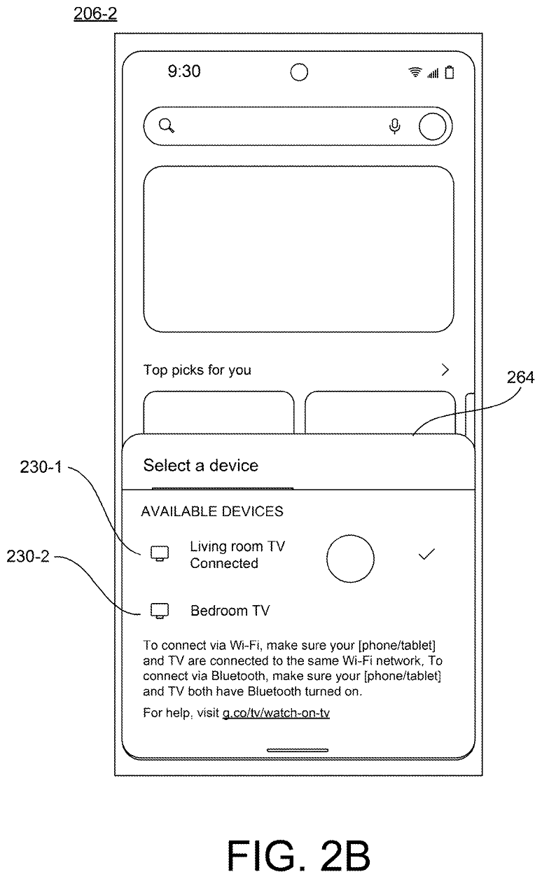

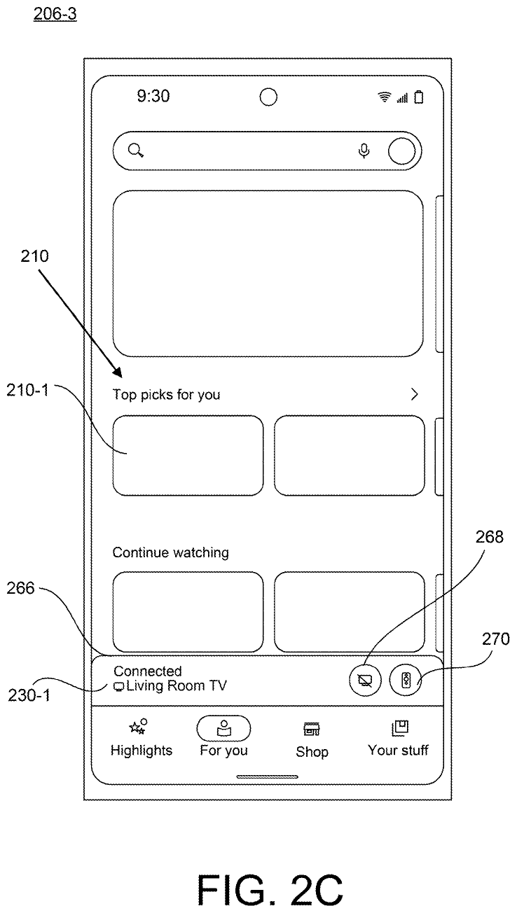

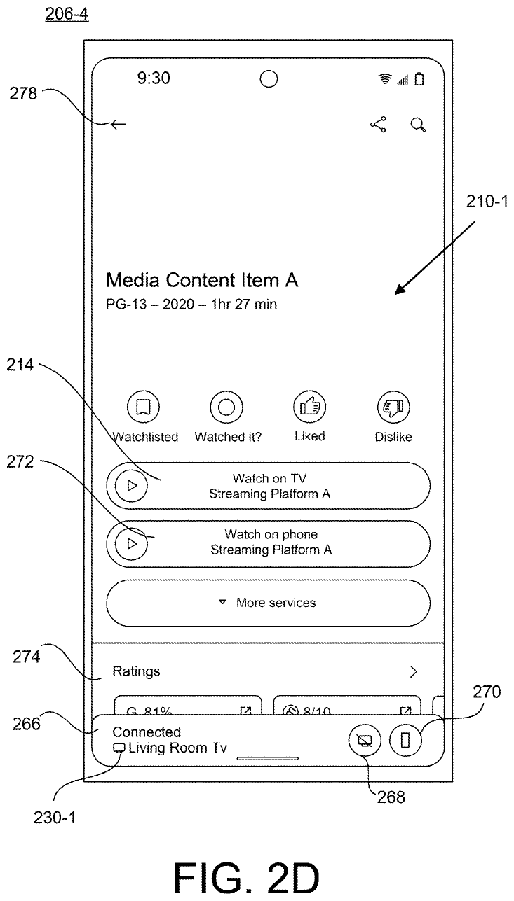

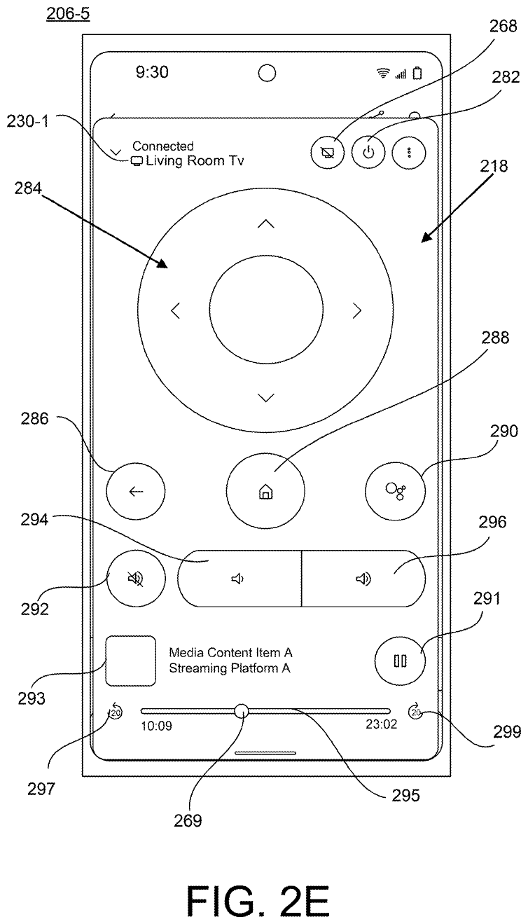

FIGS. 2A through 2E illustrates example user interfaces of a media aggregator application for connecting the media aggregator application to a display device, initiating playback of a media content item 210-1 on the display device, and controlling the playback of the media content item 210-1 on the display device. The user interfaces of FIGS. 2A through 2E may be examples of the user interface 106 of FIGS. 1A through 1C and may include any of the details discussed with reference to FIGS. 1A to 1C. As shown in FIG. 2A, a user interface 206-1 may display a plurality of media content items 210 available for streaming from a plurality of streaming platforms. The media content items 210 include a media content item 210-1 associated with a streaming platform (e.g., HBO Max™). Also, the user interface 206-1 includes a UI control 262 that indicates that one or more display devices are nearby, and, in response to selection of the UI control 262, the media aggregator application may render a user interface 206-2 as shown in FIG. 2B.

As shown in FIG. 2B, the user interface 206-2 may include an interface object 264 that identifies any available devices, including a display device 230-1 and a display device 230-2. The user may select one of the available devices to connect to the media aggregator application (e.g., the media aggregator application 104a of FIG. 1A to 1C). In response to selection of the display device 230-1, the media aggregator application may render a user interface 206-3 as shown in FIG. 2C. In FIG. 2C, the user interface 206-3 may include an interface object 266 that depicts which device (e.g., display device 230-1) is connected to the media aggregator application. Also, the interface object 266 may display one or more controls with respect to the connected display device 230-1 such as a UI control 268 for disconnecting the display device 230-1 and a UI control 270 for displaying a virtual remote (e.g., a virtual remote 218). For example, in response to selection of the UI control 268, the media aggregator application may disconnect the display device 230-1 from the media aggregator application. In response to selection of the UI control 270, the media aggregator application may display the virtual remote (e.g., the virtual remote 218). Also, the user interface 206-3 continues to display the media content items 210 for selection.

In response to selection of the media content item 210-1, the media aggregator application may render a user interface 206-4 as shown in FIG. 2D. The user interface 206-4 may provide additional information about the media content item 210-1, and one or more playback controls such as a UI control 214 for initiating playback of the media content item 210-1 on the connected display device 230-1 and a UI control 272 for initiating playback of the media content item 210-1 on a user device (e.g., the user device 102 of FIGS. 1A to 1C). The UI control 214 may be an example of the UI control 114 of FIGS. 1A through 1C. The user interface 206-4 may also include a navigation control 278, which, when selected, causes the media aggregator application to return to the user interface 206-3 of FIG. 2C.

In response to selection of the UI control 214, the media aggregator application may initiate the playback of the media content item 210-1 on the connected display device 230-1 according to the techniques discussed with reference to FIGS. 1A through 1C. Also, in some examples, after the playback of the media content item 210-1 on the connected display device 230-1 is initiated, the media aggregator application may continue to display the user interface 206-3 to permit the user to view additional information 274 about the media content item 210-1 and/or return to user interface 206-3 of FIG. 2C to view other media content items 210. Also, the user interface 206-3 displays an interface object 266 that identifies the connected display device 230-1 and includes the UI control 268 for disconnecting the connected display device 230-1 and the UI control 270 for displaying a virtual remote.

In response to selection of the UI control 270 on FIG. 2D, the media aggregator application may render a user interface 206-5 as shown in FIG. 2E. The user interface 206-5 includes a virtual remote 218. The virtual remote 218 may include a UI control 268, which, when selected, causes the connected display device 230-1 to be disconnected. The virtual remote 218 may include a power control 282, which, when selected, causes the connected display device 230-1 to be powered-on or powered-off. The virtual remote 218 includes a navigation control 284 that allows the user to navigate to different UI elements that are displayed on a display of the connected display device 230-1. Also, the virtual remote 218 includes a back navigation control 286 that enables the user to navigate to a previous interface displayed on the connected display device 230-1. The virtual remote 218 may include a home control 288 that enables the user to return to a home screen on the connected display device 230-1, and a voice assistant control 290, which, when selected, enables the user to provide voice commands.

The virtual remote 218 includes a mute control 292, which, when selected, causes the volume of the connected display device 230-1 to be muted. The virtual remote 218 includes a volume control element 294 and a volume control element 296 that controls the volume of the connected display device 230-1. The virtual remote 218 includes media item information 293 that identifies the name of the media content item 210-1 and the name of the streaming platform. The virtual remote 218 includes a pause control 291, which, when selected, causes playback of the media content item 210-1 to be paused. The virtual remote 218 includes a timeline 295 with a slider 269 that shows the progress of the playback of the media content item 210-1.

The user may move the slider 269 to fast forward and rewind. The virtual remote 218 may include a rewind control 297, which, when selected, causes the media content item 210-1 to rewind by a predetermined amount (e.g., ten seconds, thirty seconds, etc.), and a forward control 299, which, when selected, causes the media content item 210-1 to skip ahead by a predetermined amount (e.g., ten seconds, thirty seconds, etc.).

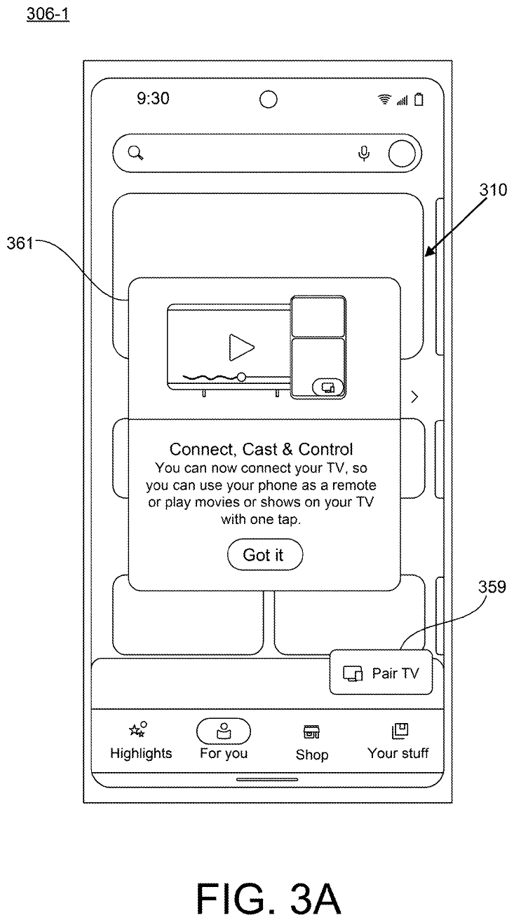

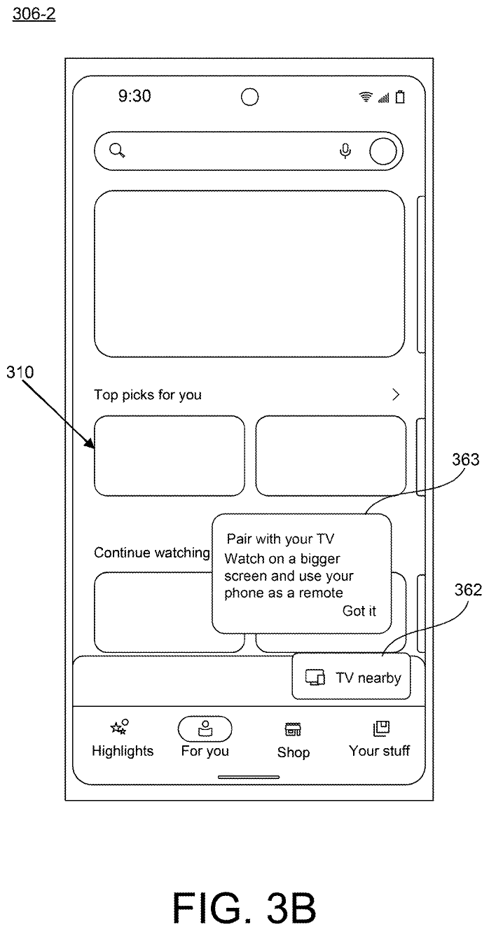

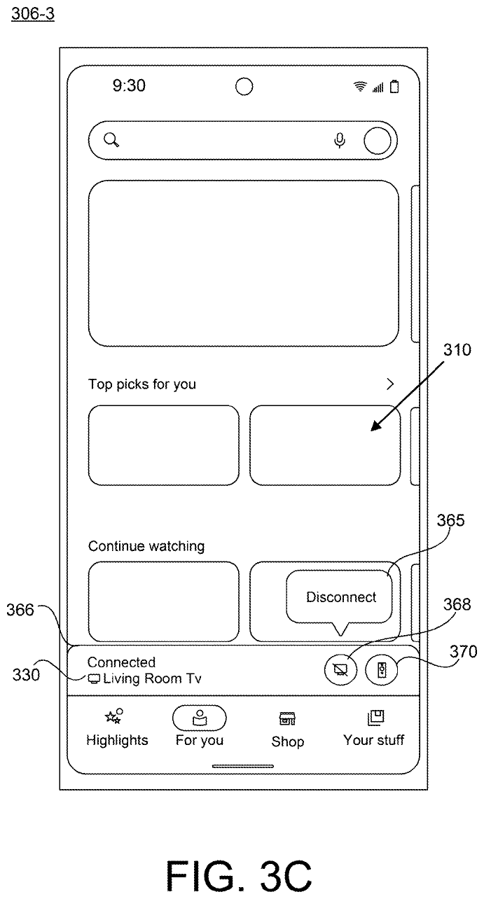

FIGS. 3A through 3C illustrate example user interfaces of a media aggregator application for connecting the media aggregator application to a display device 330, initiating playback of a media content item 310 on the display device 330, and controlling the play back of the media content item 310 on the display device 330. The user interfaces of FIGS. 3A through 3C may be examples of the user interface 106 of FIGS. 1A through 1C and may include any of the details discussed with reference to FIGS. 1A to 1C.

As shown in FIG. 3A, a user interface 306-1 may display a plurality of media content items 310 available for streaming from a plurality of streaming platforms. In some examples, for a period of time after the connect, cast, and control feature is enabled on the media aggregator application, the user interface 306-1 may include an information object 361 that provides information about the connect, cast, and control feature. Also, the user interface 306-1 includes a UI control 359, which, when selected, initiates the pairing of a display device 330 with the media aggregator application.

As shown in FIG. 3B, the media aggregator application may render a user interface 306-1 that displays a plurality of media content items 310 and a UI object 362 that indicates that one or more available display devices are nearby (e.g., after the media aggregator application has initiated a Wi-Fi or Bluetooth scan). In some examples, for a period of time after the connect, cast, and control feature is enabled on the media aggregator application, the user interface 306-2 may include an information object 363 that provides information about pairing and casting media content items on a larger screen. Also, the user interface 306-2 includes a UI object 362 that indicates that one or more display devices are nearby, and, in response to selection of the UI object 362, the media aggregator application may render a user interface to allow the user to select one of the available display devices (e.g., the user interface 206-2 as shown in FIG. 2B).

After the display device 330 is connected, the media aggregator application may render a user interface 306-3, which includes a plurality of media content items 310 associated with a plurality of streaming platforms, and an interface object 366 that identifies which display device 330 is connected to the media aggregator application and one or more UI controls such as a UI control 368 for disconnecting the display device 330 from the media aggregator application and a UI control 370 for displaying a virtual remote. In some examples, for a period of time after the connect, cast, and control feature is enabled on the media aggregator application, the user interface 306-3 may include an information object 365 that provides information about the UI control 368.

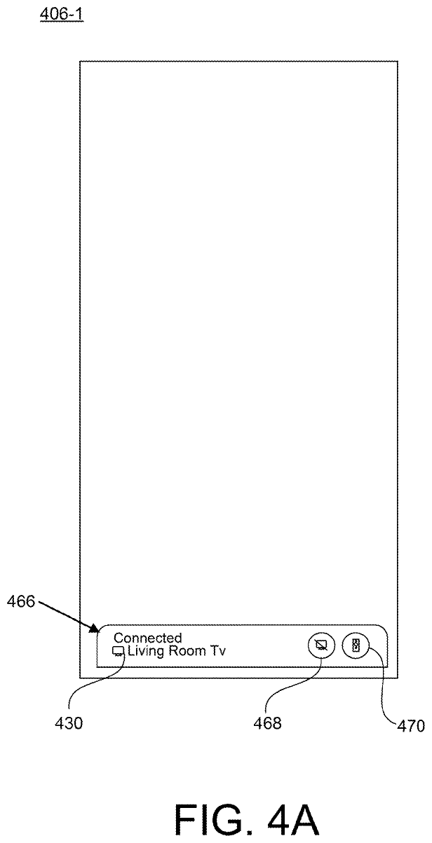

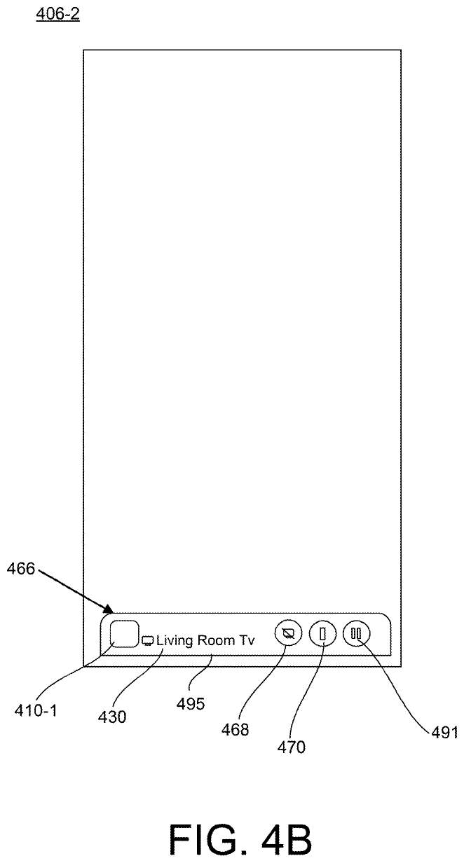

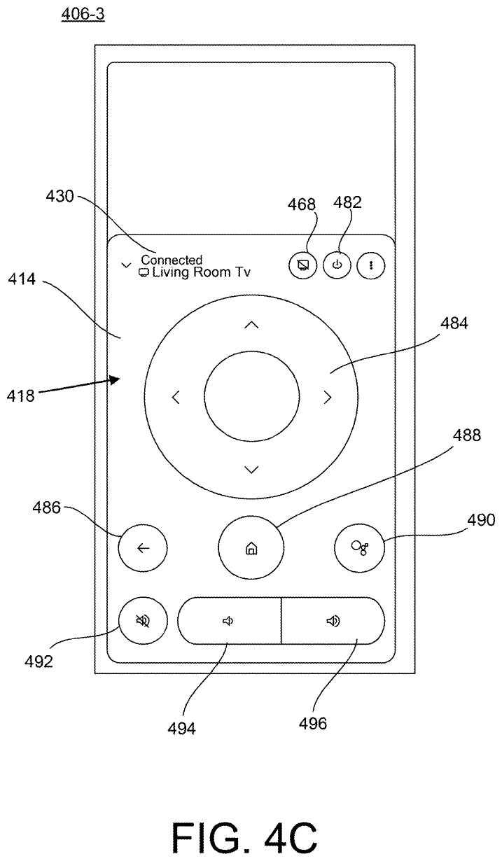

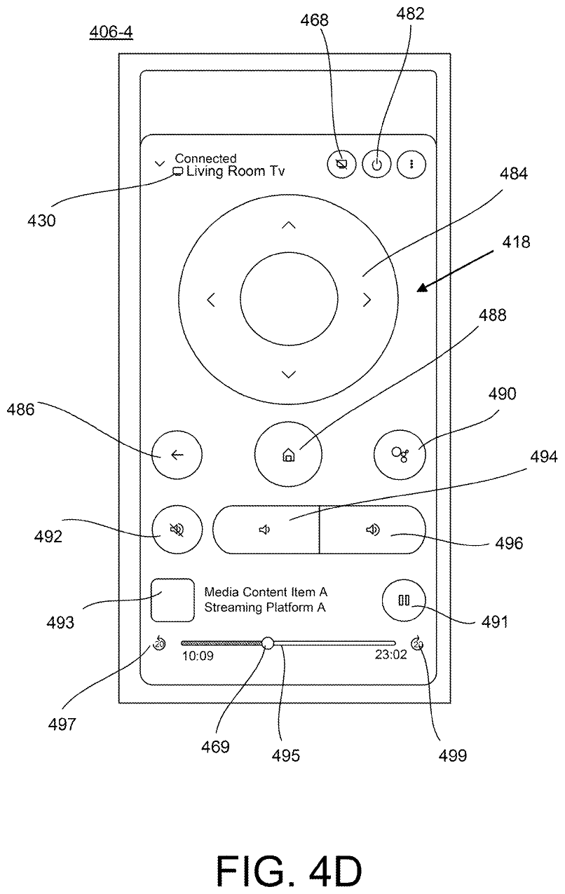

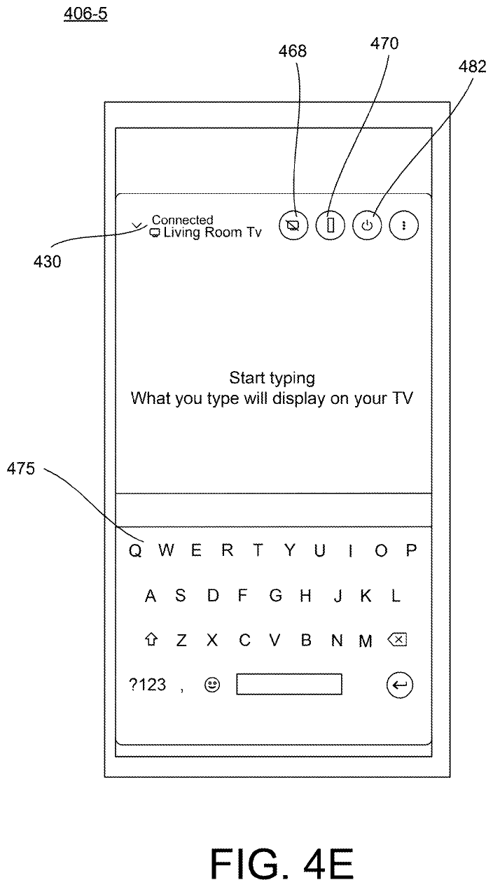

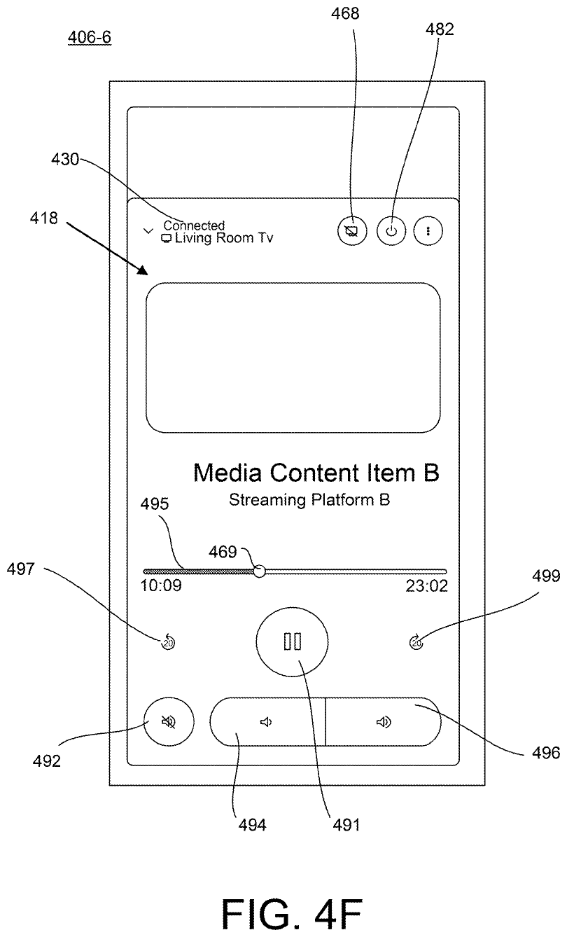

FIGS. 4A through 4F illustrate example user interfaces of a media aggregator application for connecting the media aggregator application to a display device and initiating and controlling playback of a media content item on the display device. The user interfaces of FIGS. 4A through 4F may be examples of the user interface 106 of FIGS. 1A through 1C and may include any of the details discussed with reference to FIGS. 1A to 1C.

As shown in FIG. 4A, a user interface 406-1 includes an interface object 466 that depicts which device (e.g., display device 430) is connected to the media aggregator application. Also, the interface object 466 may display one or more controls with respect to the connected display device 430 such as a UI control 468 for disconnecting the display device 430 and a UI control 470 for displaying a virtual remote. For example, in response to selection of the UI control 468, the media aggregator application may disconnect the display device 430 from the media aggregator application. In response to selection of the UI control 470, the media aggregator application may display the virtual remote. In some examples, the interface object 466 is displayed when a media content item has not been selected for play back on the display device 430.

As shown in FIG. 4B, a user interface 406-2 includes an interface object 466 that depicts which device (e.g., display device 430) is connected to the media aggregator application. In some examples, the interface object 466 in the user interface 406-2 is displayed when a media content item 410-1 has been selected for playback on the display device 430. Also, the interface object 466 may display one or more controls with respect to the connected display device 430 such as a UI control 468 for disconnecting the display device 430 and a UI control 470 for displaying a virtual remote. Also, the interface object 466 may include a pause control 491, which, when selected, causes the media content item 410-1 to be paused. The interface object 466 may include a timeline 495 that depicts a progress of the media content item 410-1.

Also, the interface object 466 may include information that identifies the media content item 410-1 that is currently playing.

As shown in FIG. 4C, a user interface 406-3 includes a virtual remote 414. In some examples, the virtual remote 414 is displayed when a media content item is not being played back on a display device. The virtual remote 418 may include a UI control 468, which, when selected, causes the connected display device 430 to be disconnected. The virtual remote 418 may include a power control 482, which, when selected, causes the connected display device 430 to be powered-on or powered-off.

The virtual remote 418 includes a navigation control 484 that allows the user to navigate to different UI elements that are displayed on a display of the connected display device 430. Also, the virtual remote 418 includes a back navigation control 486 that enables the user to navigate to a previous interface displayed on the display of the connected display device 430. The virtual remote 418 may include a home control 488 that enables the user to return to a home screen on the connected display device 430, and a voice assistant control 490, which, when selected, enables the user to provide voice commands. The virtual remote 418 includes a mute control 492, which, when selected, causes the volume of the connected display device 430 to be muted.

The virtual remote 418 includes a volume control element 494 and a volume control element 496 that controls the volume of the connected display device 430.

As shown in FIG. 4D, a user interface 406-4 includes a virtual remote 418. In some examples, the virtual remote 418 is displayed when a media content item 410-1 is being played back on a display device 430. The virtual remote 418 may include a UI control 468, which, when selected, causes the connected display device 430 to be disconnected. The virtual remote 418 may include a power control 482, which, when selected, causes the connected display device 430 to be powered-on or powered-off. The virtual remote 418 includes a navigation control 484 that allows the user to navigate to different UI elements that are displayed on the connected display device 430. Also, the virtual remote 418 includes a back navigation control 486 that enables the user to navigate to a previous interface displayed on the display of the connected display device 430. The virtual remote 418 may include a home control 488 that enables the user to return to a home screen on the connected display device 430, and a voice assistant control 490, which, when selected, enables the user to provide voice commands. The virtual remote 418 includes a mute control 492, which, when selected, causes the volume of the connected display device 430 to be muted. The virtual remote 418 includes a volume control element 494 and a volume control element 496 that controls the volume of the connected display device 430.

As shown on FIG. 4D, the virtual remote 418 includes media item information 493 that identifies the name of the media content item 410-1 and the name of the streaming platform. The virtual remote 418 includes a pause control 491, which, when selected, causes play back of the media content item 410-1 to be paused. The virtual remote 418 includes a timeline 495 with a slider 469 that shows the progress of the playback of the media content item 410-1. The user may move the slider 469 to navigation to fast forward and rewind. The virtual remote 418 may include a rewind control 497, which, when selected, causes the media content item 410-1 to rewind by a predetermined amount, and a forward control 499, which, when selected, causes the media content item 410-1 to skip ahead by a predetermined amount.

As shown in FIG. 4E, a user interface 406-5 may include a keyword interface 475 to enable the user to enter characters on the connected display device 430. The user interface 406-5 includes information that identifies the connected display device 430, a UI control 468 for disconnecting the connected display device 430, a UI control 470 for displaying a virtual remote, and a power control 482 for turning the connected display device 430 off and on.

As shown on FIG. 4F, a user interface 406-6 includes a virtual remote 418 according to another aspect. The virtual remote 418 includes information that identifies the connected display device 430, a UI control 468 for disconnecting the connected display device 430, a power control 482 for turning the connected display device 430 off and on, a pause control 491, which, when selected, causes playback of the media content item 410-1 to be paused, a timeline 495 with a slider 469 that shows the progress of the playback of the media content item 410-1, a rewind control 497, which, when selected, causes the media content item 410-1 to rewind by a predetermined amount, and a forward control 499, which, when selected, causes the media content item 410-1 to skip ahead by a predetermined amount, a mute control 492, which, when selected, causes the volume of the connected display device 430 to be muted, and a volume control element 494 and a volume control element 496 that controls the volume of the connected display device 430.

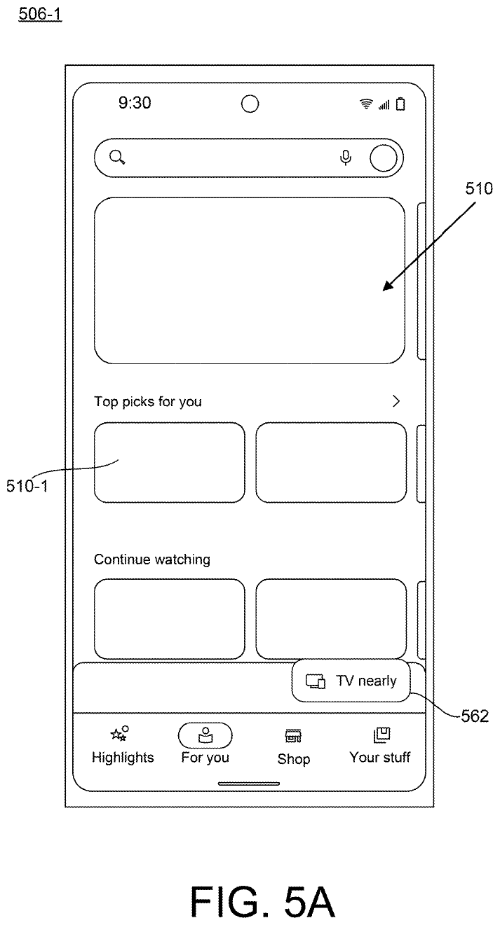

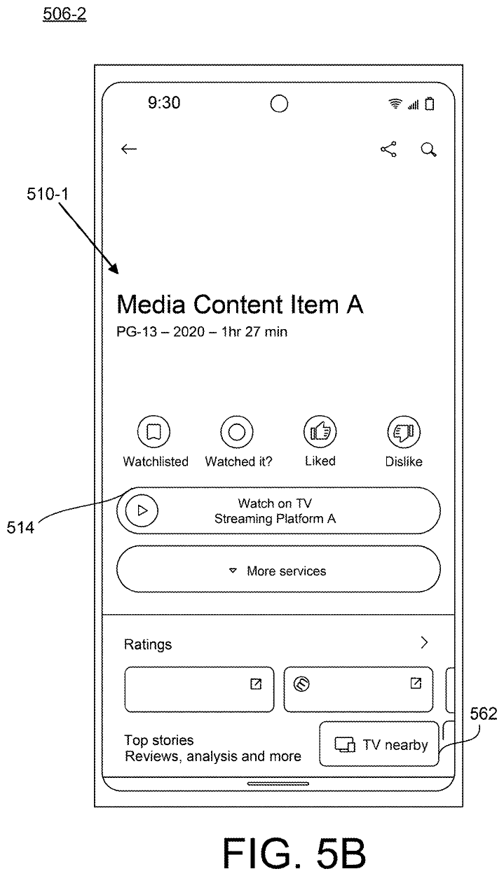

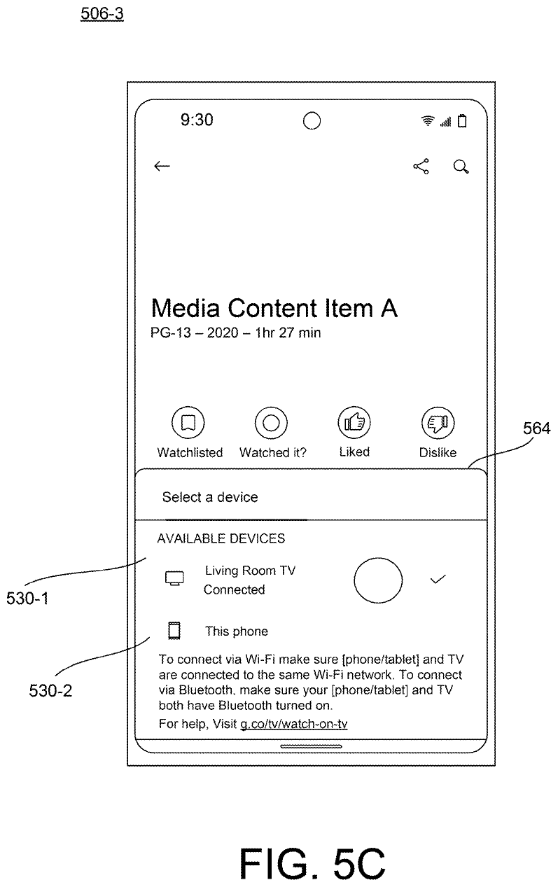

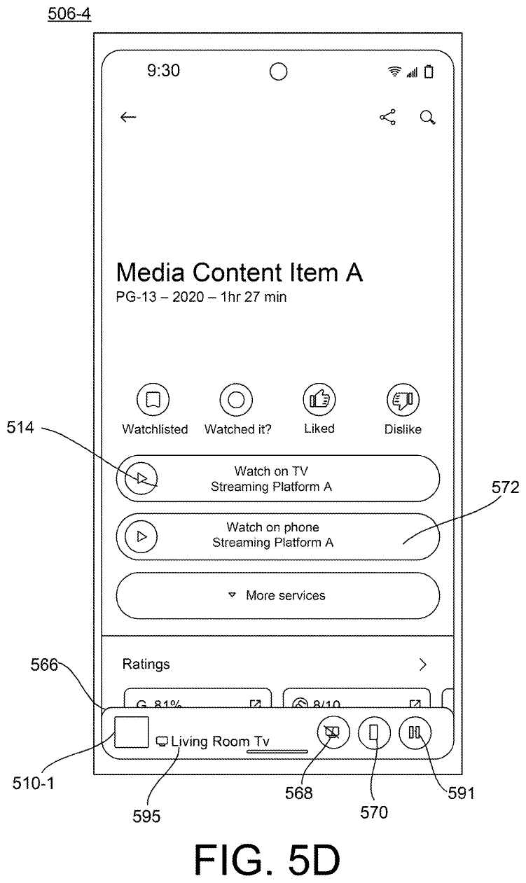

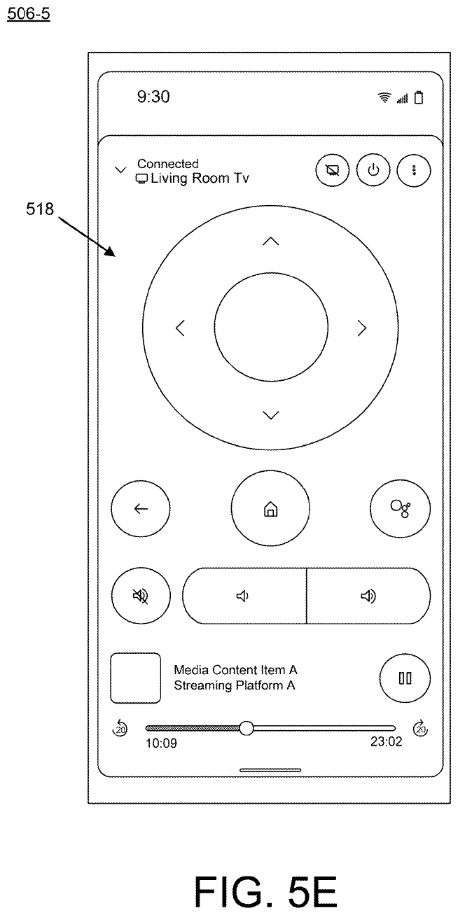

FIGS. 5A through 5E illustrate example user interfaces of a media aggregator application for connecting the media aggregator application to a display device and initiating play back and control of a media content item 510-1 on the display device. The user interfaces of FIGS. 5A through 5E may be examples of the user interface 106 of FIGS. 1A through 1C and may include any of the details discussed with reference to FIGS. 1A to 1C. As shown in FIG. 5A, a user interface 506-1 may display a plurality of media content items 510 available for streaming from a plurality of streaming platforms. The media content items 510 include a media content item 510-1 associated with a streaming platform (e.g., HBO Max™). Also, the user interface 506-1 includes a UI object 562 that indicates that one or more display devices are nearby, and, in response to selection of the UI object 562.

In response to the selection of the media content item 510, the media aggregator application may render a user interface 506-2 of FIG. 5B. The user interface 506-2 may provide additional information about the media content item 510-1, and a UI control 514 for streaming the media content item 510-1. The user interface 506-2 may also include a UI object 562 that indicates that one or more display devices are nearby.

In response to the selection of the UI object 562, the media aggregator application may render a user interface 506-3, which includes an interface object 564 that identifies any available devices, including a display device 530-1 and a display device 530-2. The user may select one of the available devices to connect to the media aggregator application.

In response to the selection of the display device 530-1 on FIG. 5C, the media aggregator application may render a user interface 506-4 as shown in FIG. 5D. The user interface 506-4 includes additional information about the media content item 510-1, and one or more playback controls such as a UI control 514 for casting the media content item 510-1 on the connected display device 530-1 and a UI control 572 for playing back the media content item 510-1 on the user device. The UI control 514 may be an example of the UI control 114 of FIGS. 1A through 1C. In response to selection of the UI control 514, the media aggregator application may initiate the playback of the media content item 510-1 on the connected display device 530-1 according to the techniques discussed with reference to FIGS. 1A through 1C.

The user interface 506-4 includes an interface object 566 that depicts which device (e.g., display device 530-1) is connected to the media aggregator application. Also, the interface object 566 may display one or more controls with respect to the connected display device 530-1 such as a UI control 568 for disconnecting the display device 530-1 and a UI control 570 for displaying a virtual remote. Also, the interface object 566 may include a pause control 591, which, when selected, causes the media content item 510-1 to be paused. The interface object 566 may include a timeline 595 that depicts a progress of the media content item 510-1.

Also, the interface object 566 may include information that identifies the media content item 410-1 that is currently playing. As shown in FIG. 5E, a user interface 506-5 may include a virtual remote 518. The virtual remote 518 may include any of the features as discussed with reference to FIG. 2E.

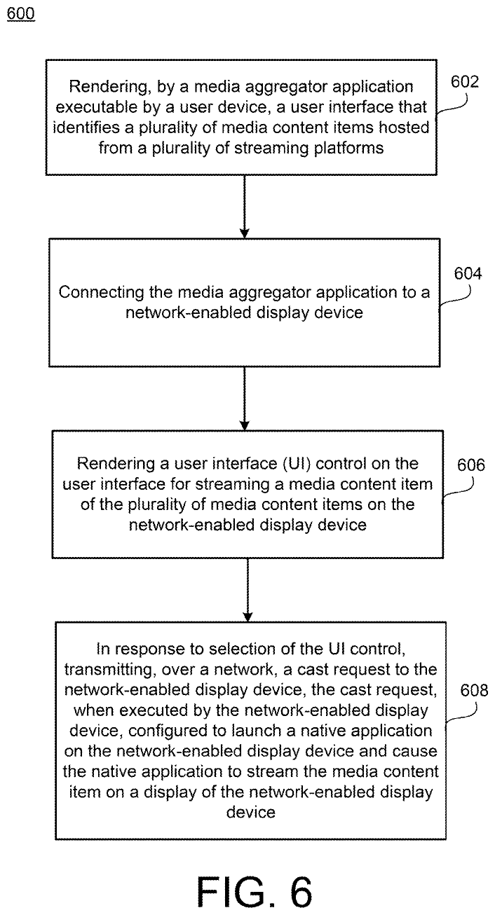

FIG. 6 illustrates a flowchart 600 depicting example operations of connecting a media aggregator application, executing on a user device, to a network-enabled display device and initiating playback and/or control of a media content item from (e.g., directly from) the media aggregator application on the network-enabled display device's display according to an aspect. Although the flowchart 600 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion. The operations may define a computer-implemented method. Although the flowchart 600 is described with reference to the system 100 of FIGS. 1A through 1C, the flowchart 600 may be executed according to any of the figures discussed herein. In some examples, the operations of the flowchart 600 are executed by a media aggregator application.

Operation 602 includes rendering, by a media aggregator application 104a executable by a user device 102, a user interface 106 that identifies a plurality of media content items 110 hosted by a plurality of streaming platforms 160. Operation 604 includes connecting the media aggregator application 104a to a network-enabled display device (e.g., display device 130). Operation 606 includes rendering a user interface (UI) control 114 on the user interface 106 for streaming a media content item 110-1 of the plurality of media content items 110 on the network-enabled display device.

Operation 608 includes, in response to selection of the UI control 114, transmitting, over a network 150, a cast request 121 to the network-enabled display device. The cast request 121, when executed by the network-enabled display device, is configured to launch a native application 116b-1 on the network-enabled display device and cause the native application 116b-1 to stream the media content item 110-1 on a display 132 of the network-enabled display device.

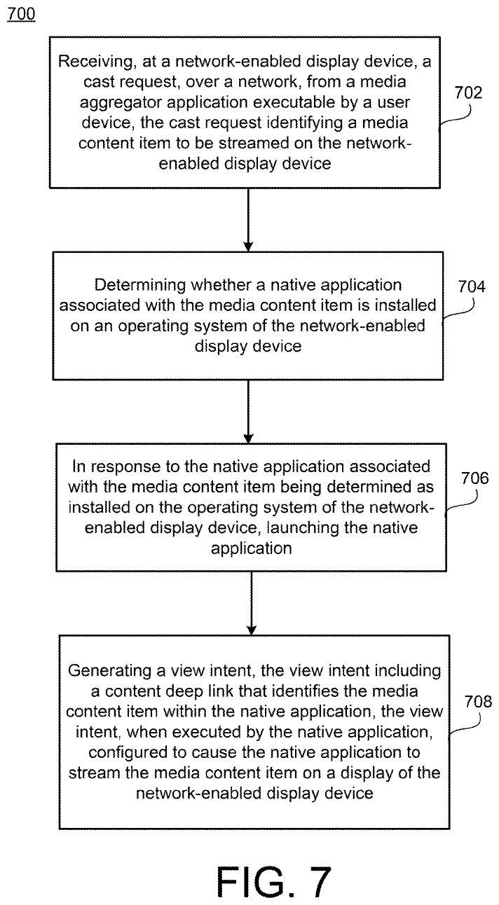

FIG. 7 illustrates a flowchart 700 depicting example operations of connecting a media aggregator application, executing on a user device, to a network-enabled display device and initiating playback and/or control of a media content item from (e.g., directly from) the media aggregator application on the network-enabled display device's display according to an aspect. Although the flowchart 700 of FIG. 7 illustrates the operations in sequential order, it will be appreciated that this is merely an example, and that additional or alternative operations may be included. Further, operations of FIG. 7 and related operations may be executed in a different order than that shown, or in a parallel or overlapping fashion. The operations may define a computer-implemented method. Although the flowchart 700 is described with reference to the system 100 of FIGS. 1A through 1C, the flowchart 700 may be executed according to any of the figures discussed herein. In some examples, the operations of the flowchart 700 are executed by a network-enabled display device.

Operation 702 includes receiving, at a network-enabled display device (e.g., display device 130), a cast request 121, over a network 150, from a media aggregator application 104a executable by a user device 102, the cast request 121 identifying a media content item 110-1 to be streamed on the network-enabled display device. Operation 704 includes determining whether a native application 116b-1 associated with the media content item 110-1 is installed on an operating system 135 of the network-enabled display device. Operation 706 includes, in response to the native application 116b-1 associated with the media content item 110-1 being determined as installed on the operating system 135 of the network-enabled display device, launching the native application 116b-1.

Operation 708 includes generating a view intent 138, the view intent 138 including a content deep link 112-1 that identifies the media content item 110-1 within the native application 116b-1, the view intent 138, when executed by the native application 116b-1, configured to cause the native application 116b-1 to stream the media content item 110-1 on a display 132 of the network-enabled display device.

In some examples, the cast request includes a content deep link that identifies the media content item within the native application, and the content deep link is configured to be used by the network-enabled display device to play back content of the media content item. In some examples, the operations include receiving, from a server computer, information that identifies the plurality of media content items and a plurality of content deep links associated with the plurality of media content items. In some examples, the cast request includes a launch request that includes an application identifier associated with the native application. In some examples, the operations include, in response to the native application being launched, receiving, over the network, a launch response from the network-enabled display device.

In some examples, the operations include, in response to the launch response, transmitting, over the network, a media load request to the network-enabled display device, the media load request including a content deep link that identifies the media content item within the native application. In some examples, the operations include rendering a virtual device remote on the user interface of the media aggregator application, where the virtual device remote is configured to control at least one of playback of the media content item or a function of the network-enabled display device. In some examples, the operations include receiving, over the network, a media status message from the network-enabled display device and updating a display aspect of the virtual device remote based on the media status message.

In some examples, streaming of the media content item on the display of the network-enabled display device is initiated from the media aggregator application, and the operations include, in response to the media content item being streamed on the display of the display device, continue to display the user interface of the media aggregator application. In some examples, the network-enabled display device is a first display device, and the operations include detecting that the first display device and a second display device is connected to a Wi-Fi network that is also connected to the user device, receiving, via the user interface of the media aggregator application, selection of the first display device, and connecting the first display device to the media aggregator application.

In some examples, the techniques described herein relate to a non-transitory computer-readable medium storing executable instructions that when executed by at least one processor cause the at least one processor to execute operations, where the operations include receiving, at a network-enabled display device, a cast request, over a network, from a media aggregator application executable by a user device, the cast request identifying a media content item to be streamed on the network-enabled display device, determining whether a native application associated with the media content item is installed on an operating system of the network-enabled display device, in response to the native application associated with the media content item being determined as installed on the operating system of the network-enabled display device, launching the native application, and generating a view intent, the view intent including a content deep link that identifies the media content item within the native application, the view intent, when executed by the native application, configured to cause the native application to stream the media content item on a display of the network-enabled display device.

In some examples, the cast request includes a launch request and the launch request includes an application identifier associated with the native application, where the application identifier is used to determine whether the native application is installed on the operating system of the network-enabled display device. In some examples, the operations include, in response to the native application being launched, transmitting, over the network, a launch response to the media aggregator application, and receiving, over the network, a media load request from the media aggregator application, the media load request including the content deep link. In some examples, the operations include receiving, at the network-enabled display device, the content deep link from a server computer. In some examples, the operations include, in response to the native application associated with the media content item being determined as not installed on the operating system of the network-enabled display device, generating an installation intent with an application identifier of the native application, where the installation intent, when executed by an online store application on the network-enabled display device, is configured to cause an installation interface to be rendered on the network-enabled display device to initiate installation of the native application.

In some examples, the techniques described herein relate to a system that includes at least one processor and a non-transitory computer-readable medium storing executable instructions that execute a media aggregator application on a user device, where the media aggregator application is configured to render a user interface that identifies a plurality of media content items from a plurality of streaming platforms, connect the media aggregator application to a network-enabled display device, render a user interface (UI) control on the user interface for streaming a media content item of the plurality of media content items on the network-enabled display device, and, in response to selection of the UI control, transmit, over a network, a cast request to the network-enabled display device, where the cast request, when executed by the network-enabled display device, is configured to launch a native application on the network-enabled display device and cause the native application to stream the media content item on a display of the network-enabled display device.

In some examples, the cast request includes a launch request that identifies an application identifier associated with the native application and the media aggregator application is configured to, in response to the native application being launched, receive, over the network, a launch response from the network-enabled display device, and, in response to the launch response, transmit, over the network, a media load request to the network-enabled display device, where the media load request includes a content deep link that identifies the media content item within the native application. In some examples, the media aggregator application is configured to render a virtual device remote on the user interface of the media aggregator application, where the virtual device remote is configured to control at least one of playback of the media content item or a function of the network-enabled display device.

In some examples, the media aggregator application is configured to receive, over the network, a media status message from the network-enabled display device and update a display aspect of the virtual device remote based on the media status message. In some examples, the media aggregator application is configured to, in response to the media content item being streamed on the display of the network-enabled display device, continue to display the user interface of the media aggregator application. In some examples, the network-enabled display device is a first display device and the media aggregator application is configured to detect that the first display device and a second display device is connected to a Wi-Fi network that is also connected to the user device, receive, via the user interface of the media aggregator application, selection of the first display device, and connect the first display device to the media aggregator application. In some examples, the system includes a network-enabled display device configured to determine whether the native application associated with the media content item is installed on an operating system of the network-enabled display device, in response to the native application associated with the media content item being determined as installed on the operating system of the network-enabled display device, launch the native application, and, generate a view intent, where the view intent includes a content deep link that identifies the media content item within the native application, and the view intent, when executed by the native application, is configured to cause the native application to stream the media content item on the display of the network-enabled display device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or non-transitory medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

1. A method comprising:
rendering, by a media aggregator application executable by a user device, a user interface that identifies a plurality of media content items hosted by a plurality of streaming platforms;
connecting the media aggregator application to a network-enabled display device;
rendering a user interface (UI) control on the user interface for streaming a media content item of the plurality of media content items on the network-enabled display device; and
in response to selection of the UI control, transmitting, over a network, a cast request to the network-enabled display device,
the cast request, when executed by the network-enabled display device, configured to launch a native application on the network-enabled display device and cause the native application to stream the media content item on a display of the network-enabled display device.

2. The method of claim 1, wherein the cast request includes a content deep link that identifies the media content item within the native application, the content deep link configured to be used by the network-enabled display device to playback content of the media content item.

3. The method of claim 1, further comprising:
receiving, from a server computer, information that identifies the plurality of media content items and a plurality of content deep links associated with the plurality of media content items.

4. The method of claim 1, wherein the cast request includes a launch request that includes an application identifier associated with the native application, the method further comprising:
in response to the native application being launched, receiving, over the network, a launch response from the network-enabled display device; and
in response to the launch response, transmitting, over the network, a media load request to the network-enabled display device,
the media load request including a content deep link that identifies the media content item within the native application.

5. The method of claim 1, further comprising:
rendering a virtual device remote on the user interface of the media aggregator application, the virtual device remote configured to control at least one of playback of the media content item or a function of the network-enabled display device.

6. The method of claim 5, further comprising:
receiving, over the network, a media status message from the network-enabled display device; and
updating a display aspect of the virtual device remote based on the media status message.

7. The method of claim 1, wherein streaming of the media content item on the display of the network-enabled display device is initiated from the media aggregator application, the method further comprising:
in response to the media content item being streamed on the display of the display device, continue to display the user interface of the media aggregator application.

8. The method of claim 1, wherein the network-enabled display device is a first display device, the method further comprising:
detecting that the first display device and a second display device is connected to a Wi-Fi network that is also connected to the user device;
receiving, via the user interface of the media aggregator application, selection of the first display device; and
connecting the first display device to the media aggregator application.

9. A non-transitory computer-readable medium storing executable instructions that when executed by at least one processor cause the at least one processor to execute operations, the operations comprising:
receiving, at a network-enabled display device, a cast request, over a network, from a media aggregator application executable by a user device, the cast request identifying a media content item to be streamed on the network-enabled display device;
determining whether a native application associated with the media content item is installed on an operating system of the network-enabled display device;
in response to the native application associated with the media content item being determined as installed on the operating system of the network-enabled display device, launching the native application; and
generating a view intent, the view intent including a content deep link that identifies the media content item within the native application,
the view intent, when executed by the native application, configured to cause the native application to stream the media content item on a display of the network-enabled display device.

10. The non-transitory computer-readable medium of claim 9, wherein the cast request includes a launch request, the launch request including an application identifier associated with the native application, wherein the application identifier is used to determine whether the native application is installed on the operating system of the network-enabled display device.

11. The non-transitory computer-readable medium of claim 10, wherein the operations further comprise:
in response to the native application being launched, transmitting, over the network, a launch response to the media aggregator application; and
receiving, over the network, a media load request from the media aggregator application, the media load request including the content deep link.

12. The non-transitory computer-readable medium of claim 9, wherein the operations further comprise:
receiving, at the network-enabled display device, the content deep link from a server computer.

13. The non-transitory computer-readable medium of claim 9, wherein the operations further comprise:
in response to the native application associated with the media content item being determined as not installed on the operating system of the network-enabled display device, generating an installation intent with an application identifier of the native application, the installation intent, when executed by an online store application on the network-enabled display device, configured to cause an installation interface to be rendered on the network-enabled display device to initiate installation of the native application.

14. A system comprising:
at least one processor; and
a non-transitory computer-readable medium storing executable instructions that execute a media aggregator application on a user device, the media aggregator application configured to:
render a user interface that identifies a plurality of media content items from a plurality of streaming platforms;
connect the media aggregator application to a network-enabled display device;
render a user interface (UI) control on the user interface for streaming a media content item of the plurality of media content items on the network-enabled display device; and
in response to selection of the UI control, transmit, over a network, a cast request to the network-enabled display device, the cast request, when executed by the network-enabled display device, configured to launch a native application on the network-enabled display device and cause the native application to stream the media content item on a display of the network-enabled display device.

15. The system of claim 14, wherein the cast request includes a launch request that identifies an application identifier associated with the native application, the media aggregator application configured to:
in response to the native application being launched, receive, over the network, a launch response from the network-enabled display device; and
in response to the launch response, transmit, over the network, a media load request to the network-enabled display device, the media load request including a content deep link that identifies the media content item within the native application.

16. The system of claim 14, wherein the media aggregator application is configured to:
render a virtual device remote on the user interface of the media aggregator application, the virtual device remote configured to control at least one of playback of the media content item or a function of the network-enabled display device.

17. The system of claim 16, the media aggregator application is configured to:
receive, over the network, a media status message from the network-enabled display device; and
update a display aspect of the virtual device remote based on the media status message.

18. The system of claim 14, wherein the media aggregator application is configured to:
in response to the media content item being streamed on the display of the network-enabled display device, continue to display the user interface of the media aggregator application.

19. The system of claim 14, wherein the network-enabled display device is a first display device, the media aggregator application is configured to:
detect that the first display device and a second display device is connected to a Wi-Fi network that is also connected to the user device;
receive, via the user interface of the media aggregator application, selection of the first display device; and
connect the first display device to the media aggregator application.

20. The system of claim 14, further comprising:
a network-enabled display device configured to:
determine whether the native application associated with the media content item is installed on an operating system of the network-enabled display device;
in response to the native application associated with the media content item being determined as installed on the operating system of the network-enabled display device, launch the native application; and
generate a view intent, the view intent including a content deep link that identifies the media content item within the native application,
the view intent, when executed by the native application, configured to cause the native application to stream the media content item on the display of the network-enabled display device.
